(19) United States
(12) Patent Application Publication
(10) Pub. No.: US 2011/0166933 A1
(43) Pub. Date: Jul. 7, 2011

(54) SYSTEM AND METHOD FOR OPTIMIZATION OF DIRECT MAIL CAMPAIGN COSTS AND EFFECTIVENESS

(76) Inventors: Jeffrey C. Caplan, Wellesley, MA (US); John L. Brady, Melrose, MA (US)

(21) Appl. No.: 12/900,197

(22) Filed: Oct. 7, 2010

Related U.S. Application Data
(60) Provisional application No. 61/249,446, filed on Oct. 7, 2009.

(51) Int. Cl. G06Q 30/00

(52) U.S. Cl. 705/14.53; 705/14.49

(57) ABSTRACT

A direct mail postal optimization system and method reduces postal expenses of direct mail campaigns relative to postal expenses of conventional direct mail campaigns, while increasing customer responses to the direct mail campaign. The system and method evaluates a plurality of direct mail audience scenarios taking into consideration a postal service carrier route to minimize cost and maximize revenue generated by purchases per household receiving a direct mailing via a direct mail campaign.

### RELATED APPLICATION

This application claims priority to, and the benefit of, co-pending U.S. Provisional Application No. 61/249,446, filed Oct. 7, 2009, for all subject matter common to both applications. The disclosure of said provisional application is hereby incorporated by reference in its entirety.

### FIELD OF THE INVENTION

The present invention relates to a system and method suitable for postal optimization as it relates to direct mail campaigns, and more particularly to a system and method for reducing postal expenses of direct mail campaigns relative to postal expenses of conventional direct mail campaigns while increasing customer responses to the direct mail campaign.

### BACKGROUND OF THE INVENTION

One form of direct marketing of products and services is referred to as direct mail. Direct mail is a process used by marketing and advertising personnel who send paper mail and sometimes free giveaway items directly to customers or prospective customers using the postal service in an overall effort to increase sales. In fact, any low cost item that can be delivered by the postal service can be used in a direct mail campaign for delivery to an existing or prospective customer. Some representative items include advertising circulars, brochures, catalogs, CD-ROMs, product samples, and the like.

Mass-marketing or advertising on much of the media available today, including television, print media, radio, and the like, can be expensive. However, a direct mail campaign provides businesses with the ability to target a specific, identifiable, group of individuals who are more likely to respond to offers from companies they have had a purchasing relationship with, or individuals fitting certain criterion making them more likely to be interested in purchasing a particular product or service. This can be done at lower cost to the company relative to the other mass-marketing or advertising methods.

In many countries, direct mail represents a significant amount of the total volume of mail on any given day. As such, postal services in these countries have established special rate classes. In the United States, for example, the postal service classifies direct mail as “bulk mail”. The term “bulk mail” refers to larger quantities of mail prepared for mailing at reduced postage. Bulk mail prices are discounted from standard single-piece mail in exchange for the company sending out the bulk mailing doing some up front preparation work. Despite the existence of bulk mail prices, many companies pay full postage per piece of mail because they do not do any extra preparation work prior to depositing the mailing with the postal service.

Despite the existence of bulk mail pricing for direct mail campaigns that meet the various up front preparation criterion prior to being deposited with the postal service, and the constant refinement of mailing lists by direct mail marketers and advertisers, there remain inefficiencies within present conventional direct mail campaigns. These inefficiencies result in the company implementing the direct mail campaign paying more for postage, and sending their mailings to households that are less likely to purchase a product or service based on the receipt of the mailing, thus causing wasted postage expenses.

### SUMMARY OF THE INVENTION

There is a need for a system and method that optimizes direct mail campaigns to reduce postal expenses relative to postal expenses of conventional direct mail campaigns, while increasing customer responses to, and the effectiveness of, the direct mail campaign. The present invention is directed toward further solutions to address this need, in addition to having other desirable characteristics.

In accordance with one example embodiment of the present invention, a computer-implemented system and method optimizes the generation of a direct mail list of household addresses, A household address list containing addresses each associated with characteristics from more preferable characteristics to less preferable characteristics is compared with a pre-defined carrier route list containing a plurality of pre-defined carrier routes in such a way as to identify and create an ordered list of carrier routes from more preferable carrier routes to less preferable carrier routes. The ordered list of carrier routes is analyzed to determine a quantity of household addresses residing within each pre-defined carrier route of the plurality of carrier routes. Pre-defined postal service pricing from lower pricing to higher pricing is associated with each pre-defined carrier route based on the quantity of household addresses residing within each pre-defined carrier route. The ordered list of carrier routes, the quantity of household addresses residing within each pre-defined carrier route, and the pre-defined postal service pricing associated with each pre-defined carrier route, are transformed into an ordered direct mail list of household addresses optimized to assign relatively higher ranking to household addresses associated with the more preferable carrier routes, optimized to assign relatively higher ranking to the household addresses having a greater quantity of more preferable characteristics within each pre-defined carrier route of the plurality of carrier routes, and optimized to assign a relatively higher ranking to the pre-defined carrier routes of the plurality of pre-defined carrier routes associated with lower postal service pricing based on the quantity of household addresses residing within each pre-defined carrier route.

In accordance with aspects of the present invention, the method can further include associating each household address of the ordered household address list with a seller based on selected criteria including geographical distance between the household address and a store location. The characteristics can include selected criteria including one or more of recency of last purchase from a seller, total dollar amount of purchases by customers from the household address at the seller in a prior year, or total lifetime dollar amount of purchases by customers from the household address at the seller. The household address list can be segregated into multiple tiers, each tier representing a different degree of preference for the household address.

In accordance with further aspects of the present invention, the method can include identifying names of preferred individuals residing at each household address of the household address list and including the names of preferred individuals in the household address. The preferred individuals can be identified as such based on historical purchases attributed to the preferred individuals. The pre-defined carrier route can be obtained from a postal service.

In accordance with aspects of the present invention, the step of comparing a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes includes associating a more preferable carrier route ranking to carrier routes formed of a relatively greater quantity of household addresses having more preferable characteristics and assigning a less preferable carrier route ranking to carrier routes formed of a relatively lesser quantity of household addresses having more preferable characteristics.

In accordance with aspects of the present invention, analyzing the ordered list of carrier routes to determine a quantity of household addresses residing within each pre-defined carrier route of the plurality of carrier routes can include calculating a sum of household addresses located within each pre-defined carrier route. Associating pre-defined postal service pricing from lower pricing to higher pricing with each pre-defined carrier route based on the quantity of household addresses residing within each pre-defined carrier route can include associating each pre-defined carrier route with a pricing indicator of line of travel, high density, or saturation.

In accordance with aspects of the present invention, the household address list can include a plurality of individual customer household addresses. The household address list can include a plurality of individual prospective customer household addresses. An associative relationship can be created between a plurality of postal carrier routes and one or more seller based on selected criteria. A plurality of variables can be associated with each household address for consideration in ranking the households preferentially, the plurality of variables including total number of more preferable customer addresses, more preferable prospective customer addresses, total lifetime sales of a household address, distance of household address to a seller location, percent owner occupied household address characteristics, and/or radio/TV consumer buying power of household address location.

In accordance with one example embodiment of the present invention, a computer-implemented method for optimizing the generation of a direct mail list of household addresses includes comparing a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes. The ordered list of carrier routes is analyzed to determine a quantity of household addresses residing within each pre-defined carrier route of the plurality of carrier routes. Pre-defined postal service pricing from lower pricing to higher pricing is associated with each pre-defined carrier route based on the quantity of household addresses residing within each pre-defined carrier route. The ordered list of carrier routes, the quantity of household addresses residing within each pre-defined carrier route, and the pre-defined postal service pricing associated with each pre-defined carrier route, are transformed into an ordered direct mail list of household addresses optimized to assign relatively lower ranking to household addresses associated with the less preferable carrier routes, optimized to assign relatively higher ranking to the household addresses having a greater quantity of more preferable characteristics within each pre-defined carrier route of the plurality of carrier routes, and optimized to assign a relatively lower ranking to the pre-defined carrier routes of the plurality of pre-defined carrier routes associated with higher postal service pricing based on the quantity of household addresses residing within each pre-defined carrier route.

In accordance with one example embodiment of the present invention, a computer-implemented method for optimizing the generation of a direct mail list of household addresses includes comparing a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes. The ordered list of carrier routes is analyzed to determine a quantity of household addresses residing within each pre-defined carrier route of the plurality of pre-defined carrier routes. The pre-defined postal service pricing from lower pricing to higher pricing is associated with each pre-defined carrier route based on the quantity of household addresses residing within each pre-defined carrier route. The ordered list of carrier routes, the quantity of household addresses residing within each pre-defined carrier route, and the pre-defined postal service pricing associated with each pre-defined carrier route, are transformed into an ordered direct mail list of household addresses optimized to assign relatively higher ranking to the household addresses having a greater quantity of more preferable characteristics within each pre-defined carrier route of the plurality of pre-defined carrier routes, and relatively lower rankings to household addresses having a less preferable combination of pre-determined characteristics.

In accordance with one example embodiment of the present invention, a medium holding instructions executable in a computing device for optimizing a method of generating a direct mail list of household addresses is provided, the method as described above and herein.

In accordance with one example embodiment of the present invention, a system for optimizing the generation of a direct mail list of household addresses includes a processor configured to compare a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes. A processor can be configured to analyze the ordered list of carrier routes to determine a quantity of household addresses residing within each pre-defined carrier route of the plurality of carrier routes. A processor can be configured to associate pre-defined postal service pricing from lower pricing to higher pricing with each pre-defined carrier route based on the quantity of household addresses residing within each pre-defined carrier route. A processor can be configured to transform the ordered list of carrier routes, the quantity of household addresses residing within each pre-defined carrier route, and the pre-defined postal service pricing associated with each pre-defined carrier route, into an ordered direct mail list of household addresses optimized to assign relatively higher ranking to household addresses associated with the more preferable carrier routes, optimized to assign relatively higher ranking to the household addresses having a greater quantity of more preferable characteristics within each pre-defined, carrier route of the plurality of carrier routes, and optimized to assign a relatively higher ranking to the pre-defined carrier routes of the plurality of pre-defined carrier routes associated with lower postal service pricing based on the quantity of household addresses residing within each pre-defined carrier route. Each of the above processors can be the same processor or different processors.

In accordance with aspects of the present invention, the characteristics can be selected criteria including one or more of recency of last purchase from a seller, total dollar amount of purchases by customers from the household address at the seller in a prior year, or total lifetime dollar amount of purchases by customers from the household address at the seller. The household address list can be segregated into multiple tiers, each tier representing a different degree of preference for the household address. The household address list can include a plurality of individual customer household addresses. The household address list can include a plurality of individual prospective customer household addresses.

### BRIEF DESCRIPTION OF THE DRAWINGS

The present invention will become better understood with reference to the following description and accompanying drawings, wherein:

FIG. 1 is a diagrammatic representation of three primary address list characteristics, according to one aspect of the present invention;

FIG. 2 is a flowchart illustrating steps utilized in determining a carrier list propensity, according to one aspect of the present invention;

FIG. 3 is a flowchart illustrating steps utilized in determining a direct mail household address list, according to one embodiment of the present invention; and

FIG. 4 is a diagrammatic illustration of a computing environment suitable for implementing the method(s) of the present invention.

### DETAILED DESCRIPTION

An illustrative embodiment of the present invention relates to a direct mail postal optimization system and method that reduces postal expenses of direct mail campaigns relative to postal expenses of conventional direct mail campaigns, while increasing customer responses to the direct mail campaign. More specifically, the present invention evaluates a plurality of direct mail audience scenarios taking into consideration a postal service carrier route to minimize cost and maximize revenue generated by purchases per household receiving a direct mailing via a direct mail campaign. Conventional direct mail campaigns utilize various models to identify customer propensity and prospective customer propensity. The present invention adds to these models a model to determine carrier route propensity in an effort to leverage the postal service special rate bulk mail pricing models and deliver the most direct mail pieces to the highest quality customers or prospective customers for the least amount of postage expense.

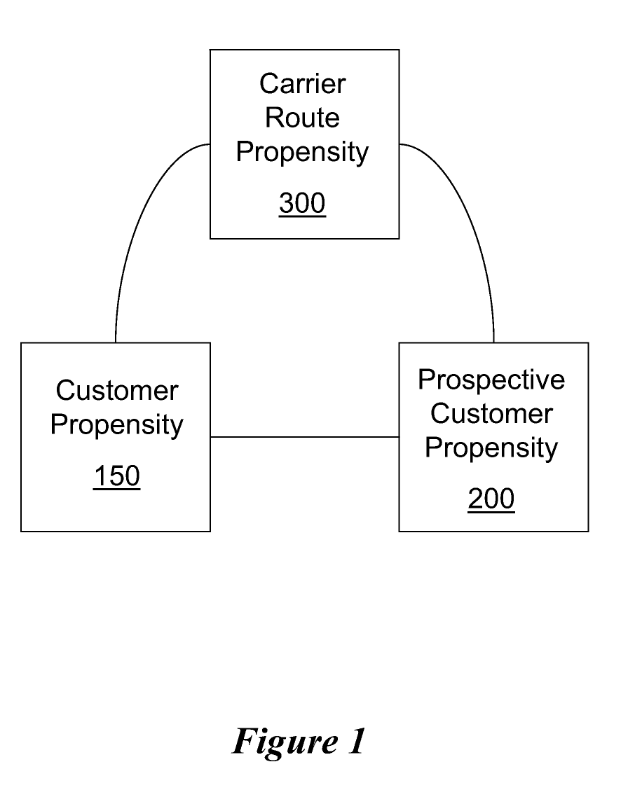

FIGS. 1 through 4, wherein like parts are designated by like reference numerals throughout, illustrate an example embodiment of a direct mail postal optimization system and method according to the present invention. Although the present invention will be described with reference to the example embodiment illustrated in the figures, it should be understood that many alternative forms can embody the present invention. One of ordinary skill in the art will additionally appreciate different ways to alter the parameters of the embodiments disclosed in a manner still in keeping with the spirit and scope of the present invention.

Conventional direct mail campaigns place substantial emphasis on mailing list hygiene. Specifically, there are a number of services available to a direct mail marketer or advertiser to help to improve the quality of their mailing lists. Some example services include: intelligent mail bar coding, which electronically tracks mail; national change of address updates; United States Postal Service (USPS) CASS™ Certification, which is a USPS service that improves the accuracy of carrier route, five-digit ZIP®, ZIP+4®, and delivery point codes that appear on mail pieces; address standardization, which takes address entries and ensures they are formatted and expressed in their official form as recognized by the USPS; postal pre-sorting, which sorts bulk mailings to the degree required by the USPS bulk mailing requirements; and delivery point validation, which through various mechanisms can validate that a mailing address is accurate and valid.

The present invention can operate in conjunction with the above-noted services, but adds another dimension to the factors considered when designing a direct mail campaign. That additional dimension is an evaluation and optimization of the mailing lists based on carrier route.

The phrase “carrier route” as utilized herein refers generally to the actual route traveled by an individual mail carrier when delivering mail. The USPS, for example, provides access to information concerning carrier routes throughout the United States. There are carrier route codes that can form a portion of each individual mailing address. Mail containing carrier route codes can be pre-sorted in such a way as to group the mail in accordance with actual carrier routes (i.e., all addresses that are visited within a single carrier route can be grouped into a single group).

As mentioned herein, postal services (including the USPS) often offer special rate, or bulk mail, pricing, with different per-mail-piece pricing depending on quantities and amount of up front preparation work performed. The phrase “bulk mail” as utilized herein is intended to include any USPS special rate pricing for bulk mail, as well as equivalents thereto in other countries. The up front preparation work required for bulk mail pricing includes, for example, such activities as pre-sorting the mail by ZIP Code, depositing the mail at a certain postal service location, or formatting the mailing label to comply with certain postal service guidelines. This preparation enables the mail to be processed more quickly and efficiently by the postal service, thereby reducing the handling costs of the postal service. Accordingly, the postal service passes on those savings to the customer with the various bulk mailing rates and categories.

The postal service may have additional guidelines relating to minimum quantities required to obtain bulk mail pricing. For example, in the United States, the U.S. Postal Service presently requires that to qualify for certain postage discounts, you must mail a minimum number of pieces:

500 pieces for First-Class Mail;

200 pieces (or 50 pounds of mail) for Standard Mail;

50 pieces for Parcel Select;

300 pieces for Presorted or Carrier Route Bound Printed Matter;

300 pieces for Library Mail; and

300 pieces for Media Mail.

In terms of carrier route specific pricing, the postal service may offer discounts based on relative number of mail pieces for delivery within each carrier route. For example, the USPS presently offers pricing for Line of Travel (LOT): deliver to minimum of 10 households but less than 125 households within a carrier route; High Density: deliver to at least 125 households within a carrier route; and Saturation: deliver to at least 90% of all households within a carrier route. Again, the above pricing structures are merely representative of what a postal service may offer. The present invention can be modified to adapt to other pricing models not specifically described herein, and as such, the present invention is in no way limited to the specific embodiments described herein for illustrative purposes.

Because of these reduced mailing rates, direct mail marketers and advertisers often seek to refine their mailing lists of existing and prospective customers such that mail is only sent to households where it will have the most advertising or marketing impact. Some mailing lists are pulled from databases after extensive analysis to find those recipients that are considered most likely to respond positively to the direct mailing. An example of this would be an individual who has demonstrated an interest in golf in a particular database may receive direct mail advertising golf related publications, goods, or services.

The present invention leverages three primary address characteristics to arrive at a refined direct mail mailing list, as shown in FIG. 1. Those three primary address characteristics are a customer propensity 150, which is determined by the utilization of existing or newly developed variables or models to identify customers; a prospective customer propensity 200, which is determined by the utilization of existing or newly developed variables or models to identify prospective customers; and a carrier route propensity 300, which relates to the potential audience size and quality of the household addresses that fall within each carrier route defined by the postal service.

The customer propensity 150 can be determined a number of different ways, using a number of different models and approaches, as would be understood by those of ordinary skill in the art. By “customer propensity” what is meant is the propensity of an identified previous customer of a particular seller to make another purchase in the future, based in part on an analysis of past purchase performance. For example, the customer propensity 150 can be determined by assessing a recency of prior purchases (e.g., how recently purchases were made) by a customer at a household from the particular seller for which the analysis is undertaken. The customer propensity 150 can be determined by a total dollar amount of spending by a household at the particular seller over the course of a year, or perhaps over a lifetime. Customer propensity 150 can be determined by additional factors and characteristics, and can likewise be determined by a combination of any of the above as well. The customer propensity 150 can be ranked from more preferable to less preferable, and can further be grouped in tiers (e.g., a gold level, silver level, bronze level, and coal level). One of ordinary skill in the art will appreciate that determination of customer propensity 150 can be made using a number of presently conventional practices, and also can include future models not yet conceived of at the time of the present invention. What is relevant to the present invention is that some form of customer propensity 150 can be determined using some form of analysis, on a per address basis.

The prospective customer propensity 200 can likewise be determined a number of different ways, using a number of different models and approaches, as would be understood by those of ordinary skill in the art. By “prospective customer propensity” what is meant is the propensity of a non-customer meeting certain criteria giving them a likelihood of being a future customer of a particular seller and to make a first purchase in the future, based in part on an analysis of various criteria. For example, the prospective customer propensity 200 can be determined by assessing such characteristics as type of household, geographical location of household, average income of neighborhood and/or household, education level of household, and many other characteristics as are conventionally reviewed when trying to identify prospective customers. Prospective customer propensity 200 can be determined by additional factors and characteristics, and can likewise be determined by a combination of any of the above as well. The prospective customer propensity 200 can be ranked from more preferable to less preferable, and can further be grouped in tiers (e.g., a gold level, silver level, bronze level, and coal level). One of ordinary skill in the art will appreciate that determination of prospective customer propensity 200 can be made using a number of presently conventional practices, and also can include future models not yet conceived of at the time of the present invention. What is relevant to the present invention is that some form of prospective customer propensity 200 can be determined using some form of analysis, on a per address basis.

The household address list can be formed of a list of customer household addresses, prospective customer household addresses, or some combination thereof, as would be understood by those of ordinary skill in the art. The household list can have additional associations made with each individual household address, such as, for example, associations with nearby seller location in embodiments where the seller has a physical location or a virtual web presence. Each household address can be further grouped by its relative distance (physical or electronic) to the seller. By “electronic distance” what is meant is the relative logistical difficulty one experiences when attempting to shop online (e.g., ability to locate seller online, connectivity capabilities, ease of user interface, etc.).

It should be noted that the term “seller” as utilized herein refers to any entity that is trading or selling, including a classically defined retailer, as well as a wholesaler, distributor, re-seller, a person or entity who promotes or exchanges goods or services for money or other goods or services, or the like, such that there is no limitation of the term “seller” as being distinct in any way with regard to its use in conjunction with the present invention.

The carrier route propensity 300 is a third variable added to the analysis that results in the ordered direct mail household address list. This variable relates to the potential audience size and quality of the customers and prospective customers at each household correlated to a particular carrier route. As with the customer propensity 150 and the prospective customer propensity 200, the carrier route propensity 300 can be determined using a number of different variables and models to arrive at an ordered list of carrier routes, including in accordance with the system and method as described herein.

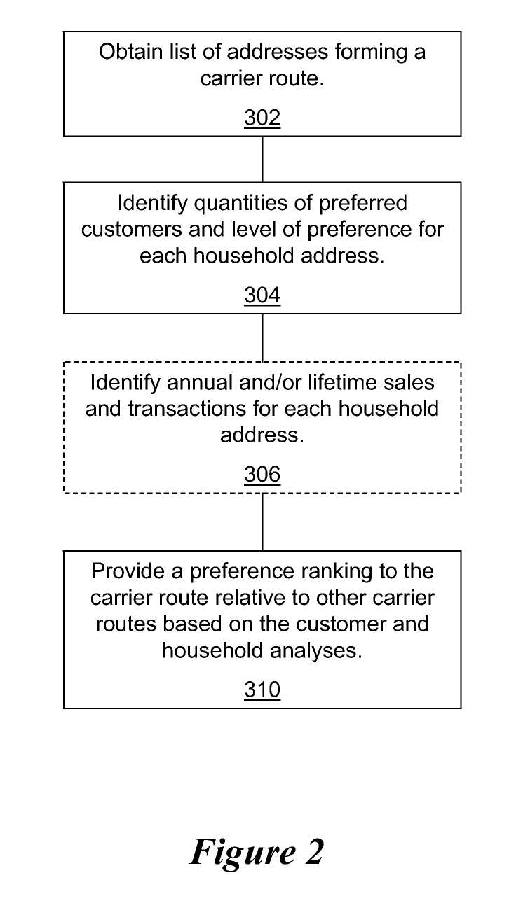

Turning now to FIG. 2, and in accordance with one example embodiment of the present invention, the carrier route propensity 300 can be determined. As noted previously, the complete list of addresses forming a carrier route is pre-defined and is determined by the responsible postal service that delivers mail. The complete list of addresses in any particular pre-defined carrier route can be analyzed to give an overall preference level for the carrier route itself. To achieve such a preference level analysis, first the complete list of addresses forming a carrier route is obtained (step 302). From that list, the method identifies quantities of preferred customers and levels of preference for each household address (step 304). The preferred customers and levels of preference can be communicated in a number of different ways, and determined by any number of conventional methods. In essence, the preferred customers and levels of preference are communicated for purposes of this step in some form of ranking, including a ranking by tiers. For example, the preferred customers and levels of preference can be represented as an ordered list of customers fitting within a tiered structure of gold customers, silver customers, bronze customers, and coal customers. Each tier of gold, silver, bronze, or coal can have its own specific meaning in a particular implementation. What matters with respect to the present invention is that the list is in a specific order and rank, which can be broken down into tiers for organizational purposes. The method can further continue with optionally identifying annual and/or lifetime sales and transactions for each household address in the carrier group (step 306) or other optional customer and address characterizations contributing to a preference ranking. Ultimately, regardless of the various criteria utilized to rank customers and households, the result is provision of a preference ranking to the carrier list relative to other carrier lists based on the customer and household analyses (step 308). This can be effected with a “score” provided on a relative scale, for example.

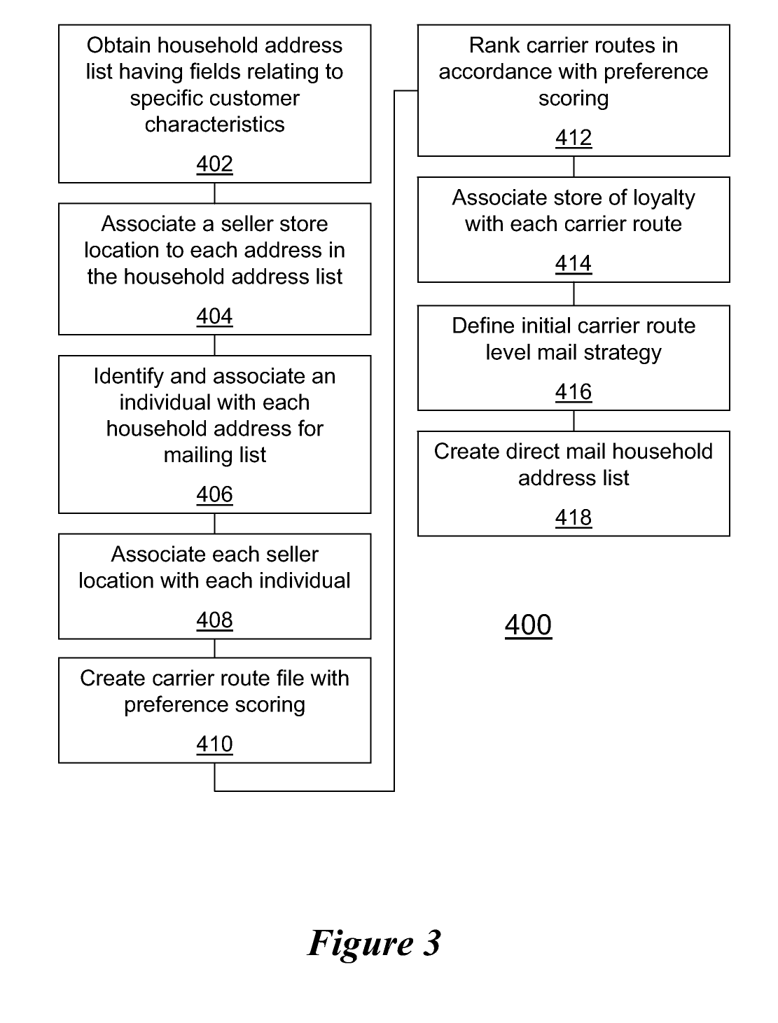

FIG. 3 illustrates an example embodiment of a method of generating an optimized direct mail list of household addresses 400 in accordance with the present invention. The method includes obtaining a household address list having fields relating to specific customer characteristics or attributes (step 402). Raw customer (and prospective customer) data can be rolled up to the household address level. Fields can be created and associated with each household address, including fields relating to recency of transactions with a seller, total dollar amount spent with a seller in a previous year, total dollar amount spent by individual(s) at the household address over a lifetime, total household income, professions of household members, evidence of prior purchasing events and habits, and many other variations of customer characteristics.

The method continues with associating or assigning a seller store location to each address in the household address list (step 404). This assignment or association creates a relationship between each address and a particular storefront or online store location, and can be based on geographical proximity, total dollars spent at a particular store, and the like. An individual name is selected for the mailing address (step 406). Again, the individual can be determined based on their prior purchases, and other customer or consumer characteristics. The method associates each seller location with each individual (step 408). The resulting list of household addresses are now associated with a plurality of characteristics enabling the ranking of the household addresses, such that an ordered household address list from more preferable household addresses to less preferable household addresses can be compiled or achieved. Whether an actual ordered list is formed, or the ordering takes place as a part of the ordering of the carrier routes based on the household address characteristics as later described herein is not directly relevant to the present invention. What matters is that the household address list contains sufficient fields of information and variables, such that it can be ordered, either itself or as a portion of a larger grouping, according to various desired criteria specific to a particular implementation.

The method continues with creating a carrier route level file with preference scoring or ranking (step 410). Preference scoring is achieved by reviewing and analyzing customer characteristics and attributes, such as total number of highly ranked customers (e.g., gold, silver, bronze, coal tiers) or customers/addresses having desirable characteristics that would lead to a high ranking, assessment of sales and transactions over specified time periods, distance to a particular store, and the like. Once the preference scoring is assigned or associated with each carrier route, the carrier routes are ranked in accordance with the preference scoring (step 412). Stores of loyalty can then be assigned to the carrier route (step 414). This step includes a review of carrier route customers. Fore example, if a carrier route includes more than 50 customers and more than 50% of the customers shop at a particular store front location, that store front is defined as a store of loyalty. This assignment can be determined using a number of different characteristics specific to particular implementations, as would be understood by those of ordinary skill in the art.

An initial carrier route level mail strategy is then developed or defined (step 416). Basic strategy can tie in with the particular postal service discounted rate structure and definitions. For example, with the USPS, there are several different levels for discounted rates, including line of travel (LOT) at a first discounted rate, high density (HD) at a more discounted rate, and saturation (SAT) at an even more discounted rate. Given such a structure, the following illustrative example provides insight as to how the strategy can be developed using one or more microprocessors of computers. One of ordinary skill in the art will appreciate that the specific steps relating to the pricing structure itself can be modified for use with different pricing structures. As such, the present invention is no limited to use with only the pricing structures described herein.

The ordered list of carrier routes is analyzed to determine a quantity of household addresses residing within each pre-defined carrier route of the plurality of carrier routes so that the appropriate discount rate can be associated with the household addresses. Pre-defined postal service pricing from lower pricing to higher pricing is associated with each pre-defined carrier route based on the quantity of household addresses residing within each pre-defined carrier route. For example, and in accordance with one illustrative example implementation of the present invention, a computing apparatus including a microprocessor marks a carrier route as LOT if it has fewer than 50 gold, sliver, or bronze customers, or it has 50-99 gold, silver, or bronze customers and has a score in the bottom 50%. The system marks a carrier route as HD if it has 50-99 gold, silver, or bronze customers and its score group is in the top 50%, or it has 100-124 gold, silver, or bronze customers and its score group is in the bottom 50%. The system marks a carrier route as HD2 (a variant of HD) if it has 100-124 gold, silver, or bronze customers and its score group is in the top 50%, or it has 124 or more gold, silver, or bronze customers. There can be exceptions to a particular strategy as laid out above, including carrier routes assigned to LOT with more than 150 customers are reassigned to HD2, or carrier routes assigned to HD or HD2 where the total customer count is 80% or more of the total household counts are reassigned to SAT. The counts are then adjusted based on a particular marketing desire or strategy, including increasing or decreasing overall volume of mail pieces.

Once any desired adjustments are made the system creates the direct mail household address list (step 418) for use in the direct mail campaign. An ordered direct mail list of household addresses is optimized to assign relatively higher ranking to household addresses associated with the more preferable carrier routes, optimized to assign relatively higher ranking to the household addresses having a greater quantity of more preferable characteristics within each pre-defined carrier route of the plurality of carrier routes, and optimized to assign a relatively higher ranking to the pre-defined carrier routes of the plurality of pre-defined carrier routes associated with lower postal service pricing based on the quantity of household addresses residing within each pre-defined carrier route. As such, this list is optimized for customer propensity 150, prospective customer propensity 200, and carrier route propensity 300, due to execution of the above process, or equivalents thereof.

Table 1 below is a table representative of an optimized address list resulting from the implementation of the present invention.

TABLE 1

| | | Carrier | | Carrier |
|---|---|---|---|---|
| # Qualified | # Qualified | Route | Carrier Route | Route |
| Customers | Prospects | Low Score | Medium Score | High Score |
| High | High | Mail SAT | Mail SAT | Mail SAT |
| High | Medium | Mail HD | Mail HD | Mail SAT |
| High | Low | Mail HD | Mail HD | Mail HD |
| Medium | High | Mail LOT | Mail HD | Mail HD |
| Medium | Medium | Mail LOT | Mail LOT | Mail HD |
| Medium | Low | Do not mail | Mail LOT | Mail LOT |
| Low | High | Do not mail | Do not mail | Do not mail |
| Low | Medium | Do not mail | Do not mail | Do not mail |
| Low | Low | Do not mail | Do not mail | Do not mail |

As can be seen in the table, the upper right-hand section represents the largest number of highest quality customers and prospects, on carrier routes having the highest score, and as such makes use of saturation (SAT) mailing. As the number of high quality customers and prospects decreases, the volume of mail pieces per carrier route decreases. Likewise, as the carrier route score decreases, the recommended volume of mail pieces decreases (from SAT, to HD, to LOT, to Do not mail).

The method as described herein is implemented on an electronic computing apparatus to enable accurate and efficient handling of all of the variables and criteria that go into the optimization of the direct mail address list. Embodiments of the present invention can be implemented in the form of computer-implemented processes and apparatuses or systems. In exemplary embodiments, the method of the present invention is embodied in computer program code executable by one or more local or distributed computing apparatuses. Embodiments include computer program code containing instructions embodied in tangible media, diskettes, CD-ROMs, hard drives, flash drives, or any other computer-readable storage medium, wherein, when the computer program code is loaded into and executed by an electronic computing apparatus, the electronic computing apparatus becomes an apparatus for practicing the invention. Embodiments include computer program code, for example, whether stored in a storage medium, loaded into and/or executed by an electronic computing apparatus, or transmitted over some transmission medium, such as over electrical wiring or cabling, through fiber optics, or via electromagnetic radiation, or wirelessly, wherein, when the computer program code is loaded into and executed by an electronic computing apparatus, the electronic computing apparatus becomes an apparatus for practicing the invention. When implemented on a general-purpose microprocessor, the computer program code segments configure the microprocessor to create specific logic circuits.

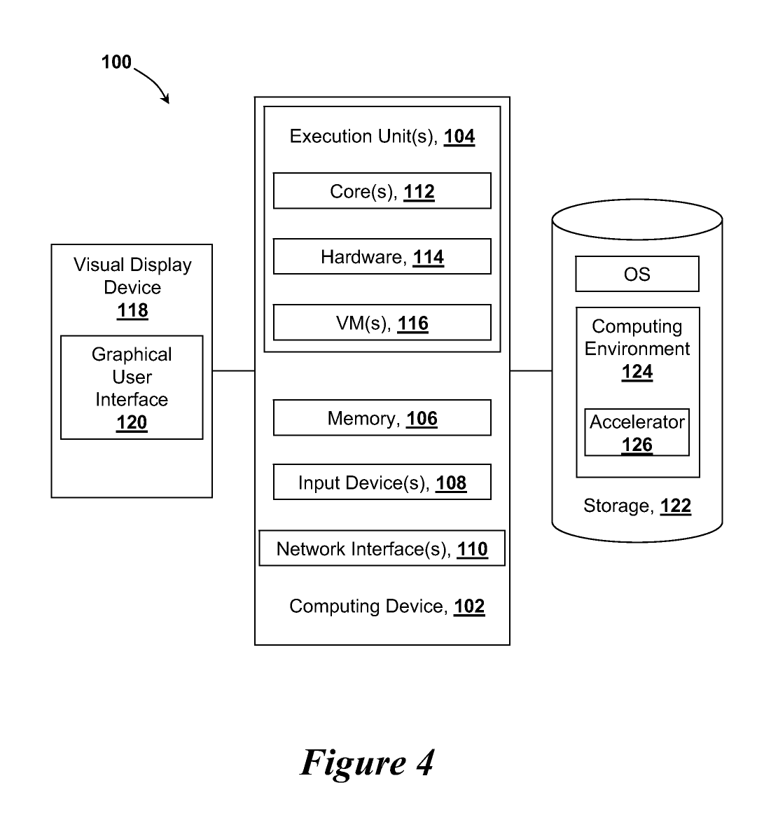

FIG. 4 depicts a computing environment 100 suitable for practicing exemplary embodiments of the present invention. A computing device 102 may include execution units 104, memory 106, input device(s) 108, and network interface(s) 110. The execution units 104 may include hardware or software based logic to execute instructions on behalf of the computing device 102. For example, depending on specific implementation requirements, execution units 104 may include: one or more processors, such as a microprocessor; single or multiple cores 112 for executing software stored in the memory 106, or other programs for controlling the computing device 102; hardware 114, such as a digital signal processor (DSP), a graphics processing unit (GPU), a field programmable gate array (FPGA), an application specific integrated circuit (ASIC), etc., on which at least a part of applications can be executed; and/or a virtual machine (VM) 116 for executing the code loaded in the memory 106 (multiple VMs 116 may be resident on a single execution unit 104).

Depending on specific implementation requirements, the memory 106 may include a computer system memory or random access memory (RAM), such as dynamic RAM (DRAM), static RAM (SRAM), extended data out RAM (EDO RAM), etc. The memory 106 may include other types of memory as well, or combinations thereof. A user may interact with the computing device 102 through a visual display device 118, such as a computer monitor, which may include a graphical user interface (GUI) 120. The computing device 102 may include other I/O devices, such a keyboard, and a pointing device (for example, a mouse) for receiving input from a user. Optionally, the keyboard and the pointing device may be connected to the visual display device 118. The computing device 102 may include other suitable conventional I/O peripherals. Moreover, depending on particular implementation requirements of the present invention, the computing device 102 may be any computer system such as a workstation, desktop computer, server, laptop, handheld computer or other appropriate form of computing or telecommunications device that is capable of communication and that has sufficient processor power and memory capacity to perform the operations described herein.

Additionally, the computing device 102 may include interfaces, such as the network interface 110, to interface to a Local Area Network (LAN), Wide Area Network (WAN), a cellular network, the Internet, or another network, through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), synchronous transfer mode (STM), wireless connections (e.g., 802.11), high-speed interconnects (e.g., InfiniBand, gigabit Ethernet, Myrinet) or some combination of any or all of the above as appropriate for a particular embodiment of the present invention. The network interface 110 may include a built-in network adapter, network interface card, personal computer memory card international association (PCMCIA) network card, card bus network adapter, wireless network adapter, universal serial bus (USB) network adapter, modem or any other device suitable for interfacing the computing device 102 to any type of network capable of communication and performing the operations described herein.

The computing device 102 may further include a storage device 122, such as a hard-drive, flash-drive, or CD-ROM, for storing an operating system (OS) and for storing application software programs, such as the computing application or environment 124. The computing environment 124 may run on any operating system such as any of the versions of the conventional operating systems, any embedded operating system, any real-time operating system, any open source operating system, any proprietary operating system, any operating systems for mobile computing devices, or any other operating system capable of running on the computing device and performing the operations described herein. Furthermore, the operating system and the computing environment 124 may in some instances be run from a bootable CD. The computing environment 124 may include an accelerator 126 that enables a computing application or computing environment 120 to compute one or more elementwise expressions in parallel.

One of ordinary skill in the art will appreciate that the above description concerning the computing environment 100 is intended to encompass all conventional computing systems suitable for carrying out methods of the present invention. As such, any variations or equivalents thereof that are likewise suitable for carrying out the methods of the present invention are likewise intended to be included in the computing environment 100 described herein. Furthermore, to the extent there are any specific embodiments or variations on the computing environment 100 that are not suitable for, or would make inoperable, the implementation of the present invention, such embodiments or variations are not intended for use with the present invention.

One of ordinary skill in the art will appreciate that the above described example embodiment is merely representative of a process that can be implemented to carry out the present invention. Specific steps described within the method can and may be done in equivalent manner, or in some instances may not be necessary for a particular implementation. As such, the present invention is by no means limited to this specific implementation example.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

What is claimed is:

1. A computer-implemented method for optimizing the generation of a direct mail list of household addresses, the method comprising:
comparing a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes;
analyzing the ordered list of carrier routes to determine a quantity of household addresses residing within each pre-defined carrier route of the plurality of carrier routes;
associating pre-defined postal service pricing from lower pricing to higher pricing with each pre-defined carrier route based on the quantity of household addresses residing within each pre-defined carrier route; and
transforming the ordered list of carrier routes, the quantity of household addresses residing within each pre-defined carrier route, and the pre-defined postal service pricing associated with each pre-defined carrier route, into an ordered direct mail list of household addresses optimized to assign relatively higher ranking to household addresses associated with the more preferable carrier routes, optimized to assign relatively higher ranking to the household addresses having a greater quantity of more preferable characteristics within each pre-defined carrier route of the plurality of carrier routes, and optimized to assign a relatively higher ranking to the pre-defined carrier routes of the plurality of pre-defined carrier routes associated with lower postal service pricing based on the quantity of household addresses residing within each pre-defined carrier route.

2. The method of claim 1, further comprising associating each household address of the ordered household address list with a seller based on selected criteria including geographical distance between the household address and a store location.

3. The method of claim 1, wherein the characteristics comprise selected criteria including one or more of recency of last purchase from a seller, total dollar amount of purchases by customers from the household address at the seller in a prior year, or total lifetime dollar amount of purchases by customers from the household address at the seller.

4. The method of claim 1, wherein the household address list is segregated into multiple tiers, each tier representing a different degree of preference for the household address.

5. The method of claim 1, further comprising identifying names of preferred individuals residing at each household address of the household address list and including the names of preferred individuals in the household address.

6. The method of claim 5, wherein the preferred individuals are identified as such based on historical purchases attributed to the preferred individuals.

7. The method of claim 1, wherein the pre-defined carrier route is obtained from a postal service.

8. The method of claim 1, wherein comparing a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes comprises associating a more preferable carrier route ranking to carrier routes formed of a relatively greater quantity of household addresses having more preferable characteristics and assigning a less preferable carrier route ranking to carrier routes formed of a relatively lesser quantity of household addresses having more preferable characteristics.

9. The method of claim 1, wherein analyzing the ordered list of carrier routes to determine a quantity of household addresses residing within each pre-defined carrier route of the plurality of carrier routes comprises calculating a sum of household addresses located within each pre-defined carrier route.

10. The method of claim 1, wherein associating pre-defined postal service pricing from lower pricing to higher pricing with each pre-defined carrier route based on the quantity of household addresses residing within each pre-defined carrier route comprises associating each pre-defined carrier route with a pricing indicator of line of travel, high density, or saturation.

11. The method of claim 1, wherein the household address list comprises a plurality of individual customer household addresses.

12. The method of claim 1, wherein the household address list comprises a plurality of individual prospective customer household addresses.

13. The method of claim 1, further comprising creating an associative relationship between a plurality of postal carrier routes and one or more seller based on selected criteria.

14. The method of claim 1, further comprising associating a plurality of variables with each household address for consideration in ranking the households preferentially, the plurality of variables including total number of more preferable customer addresses, more preferable prospective customer addresses, total lifetime sales of a household address, distance of household address to a seller location, percent owner occupied household address characteristics, and/or radio/TV consumer buying power of household address location.

15. A computer-implemented method for optimizing the generation of a direct mail list of household addresses, the method comprising:
comparing a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes;
analyzing the ordered list of carrier routes to determine a quantity of household addresses residing within each pre-defined carrier route of the plurality of carrier routes;
associating pre-defined postal service pricing from lower pricing to higher pricing with each pre-defined carrier route based on the quantity of household addresses residing within each pre-defined carrier route; and
transforming the ordered list of carrier routes, the quantity of household addresses residing within each pre-defined carrier route, and the pre-defined postal service pricing associated with each pre-defined carrier route, into an ordered direct mail list of household addresses optimized to assign relatively lower ranking to household addresses associated with the less preferable carrier routes, optimized to assign relatively higher ranking to the household addresses having a greater quantity of more preferable characteristics within each pre-defined carrier route of the plurality of carrier routes, and optimized to assign a relatively lower ranking to the pre-defined carrier routes of the plurality of pre-defined carrier routes associated with higher postal service pricing based on the quantity of household addresses residing within each pre-defined carrier route.

16. A computer-implemented method for optimizing the generation of a direct mail list of household addresses, the method comprising:
comparing a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes;
analyzing the ordered list of carrier routes to determine a quantity of household addresses residing within each pre-defined carrier route of the plurality of pre-defined carrier routes;
associating pre-defined postal service pricing from lower pricing to higher pricing with each pre-defined carrier route based on the quantity of household addresses residing within each pre-defined carrier route; and
transforming the ordered list of carrier routes, the quantity of household addresses residing within each pre-defined carrier route, and the pre-defined postal service pricing associated with each pre-defined carrier route, into, an ordered direct mail list of household addresses optimized to assign relatively higher ranking to the household addresses having a greater quantity of more preferable characteristics within each pre-defined carrier route of the plurality of pre-defined carrier routes, and relatively lower rankings to household addresses having a less preferable combination of pre-determined characteristics.

17. A medium holding instructions executable in a computing device for optimizing a method of generating a direct mail list of household addresses, the method comprising the steps of claim 1.

18. A system for optimizing the generation of a direct mail list of household addresses, the system comprising:
a processor configured to compare a household address list containing addresses each associated with characteristics from more preferable characteristics to less preferable characteristics with a pre-defined carrier route list containing a plurality of pre-defined carrier routes in such a way as to identify and create an ordered list of carrier routes from more preferable carrier routes to less preferable carrier routes;
a processor configured to analyze the ordered list of carrier routes to determine a quantity of household addresses residing within each pre-defined carrier route of the plurality of carrier routes;
a processor configured to associate pre-defined postal service pricing from lower pricing to higher pricing with each pre-defined carrier route based on the quantity of household addresses residing within each pre-defined carrier route; and
a processor configured to transform the ordered list of carrier routes, the quantity of household addresses residing within each pre-defined carrier route, and the pre-defined postal service pricing associated with each pre-defined carrier route, into an ordered direct mail list of household addresses optimized to assign relatively higher ranking to household addresses associated with the more preferable carrier routes, optimized to assign relatively higher ranking to the household addresses having a greater quantity of more preferable characteristics within each pre-defined carrier route of the plurality of carrier routes, and optimized to assign a relatively higher ranking to the pre-defined carrier routes of the plurality of pre-defined carrier routes associated with lower postal service pricing based on the quantity of household addresses residing within each pre-defined carrier route.

19. The system of claim 18, wherein the characteristics comprise selected criteria including one or more of recency of last purchase from a seller, total dollar amount of purchases by customers from the household address at the seller in a prior year, or total lifetime dollar amount of purchases by customers from the household address at the seller.

20. The system of claim 18, wherein the household address list is segregated into multiple tiers, each tier representing a different degree of preference for the household address.

21. The system of claim 18, wherein the household address list comprises a plurality of individual customer household addresses.

22. The system of claim 18, wherein the household address list comprises a plurality of individual prospective customer household addresses.
